(19) United States
(12) Patent Application Publication
(10) Pub. No.: US 2007/0262097 A1
(43) Pub. Date: Nov. 15, 2007

(54) Control tilt dispenser

(76) Inventor: Keith E. Antal,, Valatie, NY (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/801,524

(22) Filed: May 10, 2007

Related U.S. Application Data
(60) Provisional application No. 60/799,385, filed on May 10, 2006.

(51) Int. Cl. G01F 11/26

(52) U.S. Cl. 222/456

(57) ABSTRACT

A dispenser for granular or pellet material is provided having a lid covering a chamber. The lid moves between a closed position, a measured dispensing position and a non-measured pouring position. In the measured dispensing position, an opening in the lid is aligned with a dispensing channel formed in the chamber and structured to receive a limited amount of material from the chamber when the dispenser is vertical, and to move this measured material when the dispenser is tilted. The non-measured dispensing position aligns the lid opening in direct communication with the storage chamber of the dispenser.

### FIELD OF THE INVENTION

The present invention relates to a dispenser for granular or pellet products. More specifically, the invention provides a dispenser that may selectively dispense either a measured amount of product or product flow.

### BACKGROUND

The problem of dispensing substantially consistent amounts of granular or pellet material has been the subject of numerous efforts. As used herein, granular or pellet material encompasses a wide variety of different materials, such as food seasonings, salt, pepper, sugar, cinnamon, spices, household cleaners, lawn care chemicals, road salt, particulate materials, cement, stone dust, sand, or in the manufacturing industry, such as concentrates in plastic or colorants in wax, and other similar materials. Granular or pellet material may also include food items such as candy or nuts.

It is often desirable to dispense granular or pellet material in a measured quantity. Likewise, it may also be desirable to dispense a non-measured quantity of granular or pellet material by pouring the desired amount of material directly from a reservoir.

### SUMMARY OF THE INVENTION

The present invention provides a dispenser that may be used to dispense a quantity of granular or pellet material. The dispenser includes a storage chamber and a dispensing channel in communication with the storage chamber. The top and bottom of the dispensing channel each define an opening. A top wall is disposed adjacent to the top opening of the dispensing channel. A lid is provided on the dispenser having an opening defined therein. The lid is structured to move between a first position wherein the top wall closes the lid opening, a second position wherein the lid opening is substantially aligned with the dispensing channel, and a third position wherein the lid opening is in communication with the storage chamber.

A user wishing to dispense a substantially fixed quantity of granular or pellet material may position the opening in the lid cap over the dispensing channel. With the dispenser in its normal vertical, storage position, material will flow into the bottom opening of the dispensing channel. The size of the opening and the size of the dispensing channel limit the amount of material that may flow therein. Tilting the dispenser will move the material that has accumulated at the bottom of the dispensing channel through the channel and towards the opening at the top. Since the lid opening aligns with the channel opening, only the quantity of material positioned at the dispensing channel opening is dispensed. The remaining material within the chamber is blocked from dispensing by the channel wall and the lid.

To dispense a larger quantity of material or a continuous flow of material, a user may move the lid so that the lid opening is in communication with the storage chamber. Tilting the dispenser will produce a dispensing flow of material from the storage chamber until the dispenser is rotated towards a vertical orientation to stop the flow of material.

Movement of the lid to align the lid opening with the top wall, closes the chamber. The lid opening in this position is blocked by the top wall. Also, the lid closes the channel opening.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is a top perspective view of a dispenser according to the present invention, showing the lid portion in its closed position.

FIG. 2 is a top perspective view of a dispenser according to the present invention, showing the lid portion in its measured dispensing position.

FIG. 3 is a top perspective view of a dispenser according to the present invention, showing the lid portion in its pouring position.

FIG. 4 is a cross sectional view of the dispenser as taken along line 4-4 in FIG. 2.

FIG. 5 is a top perspective view of the interior of the dispenser according to the present invention, with the lid portion removed.

FIG. 6 is a top perspective view of a lid for a dispenser according to the present invention.

FIG. 7 is a bottom perspective view of a lid for a dispenser according to the present invention.

FIG. 8 is an environmental, perspective side view of a dispenser according to the present invention, showing a measured pour of material.

FIG. 9 is an environmental, perspective side view of a dispenser according to the present invention, showing a non-measured pour of material.

### DETAILED DESCRIPTION

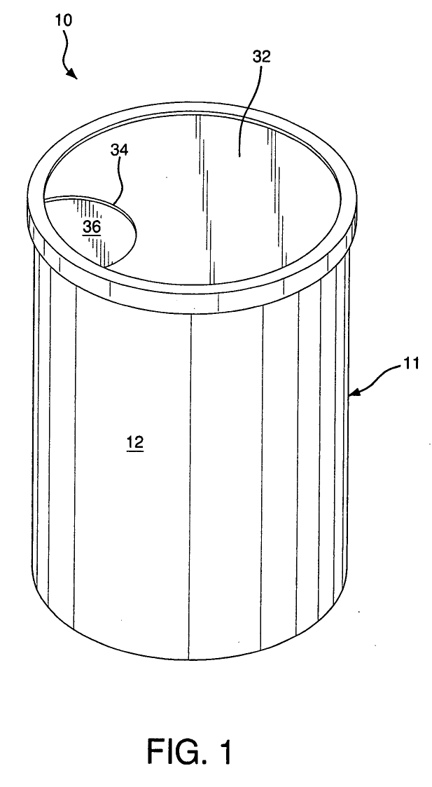

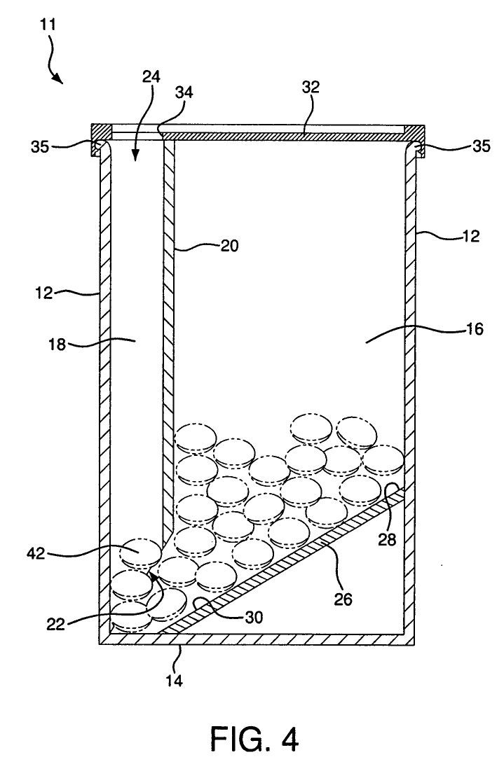

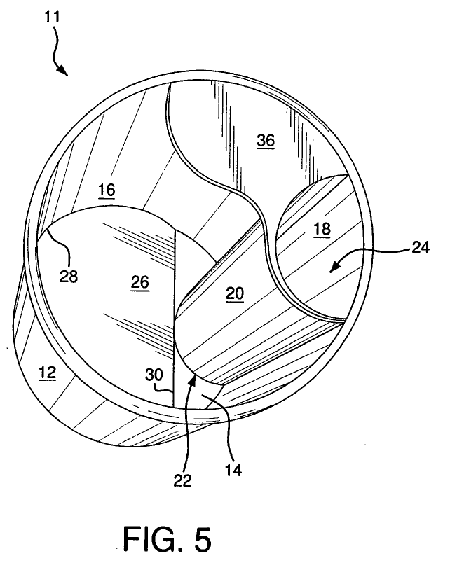

In the various figures, where like numerals identify like elements, there is shown a dispenser used for selectively dispensing either a measured amount of material or a non-measured flow of material. Referring to FIGS. 1-5, the dispenser is generally designated by the numeral 10 and includes a container portion 11 having at least one side wall 12 and a bottom 14 defining a storage chamber 16 therein. As more particularly illustrated in FIGS. 4 and 5, a dispensing channel 18 is disposed adjacent to the storage chamber 16.

As illustrated, the dispensing channel 18 is defined by a channel wall 20 which is secured to the interior wall of the chamber 16. The dispensing channel 18 is substantially vertical when the dispenser 10 is in its normal storage position. The dispensing channel 18 includes a bottom opening 22 and a top opening 24. The cross-sectional area of the dispensing channel 18 and the size of the bottom opening 22 are selected to receive a desired quantity of granular or pellet material from the storage chamber 16 when the dispenser is in its storage position. A ramp 26 having a top edge 28 opposite the dispensing channel 18, and a lower edge 30 positioned in contact with the bottom wall 14, promotes a flow of material towards the bottom opening 22 of the dispensing channel 18.

As particularly illustrated in FIG. 5, a top wall 36 is disposed adjacent to the top opening 24 of the dispensing channel 18. As illustrated, the top wall 36 is formed as part of the channel wall 20 and projects outwardly along the side wall of the chamber 16, adjacent the top opening 24 of the dispensing channel.

Referring to FIGS. 1-3 and 6-7, the dispenser 10 includes a lid 32 defining an opening 34 therein. The opening 34 in the illustrated example has substantially the same shape as the top opening 24 of the dispensing channel 18.

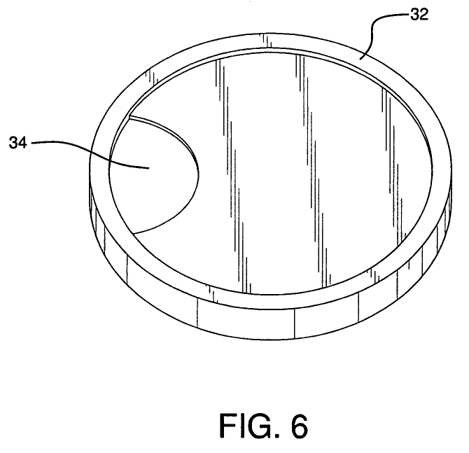

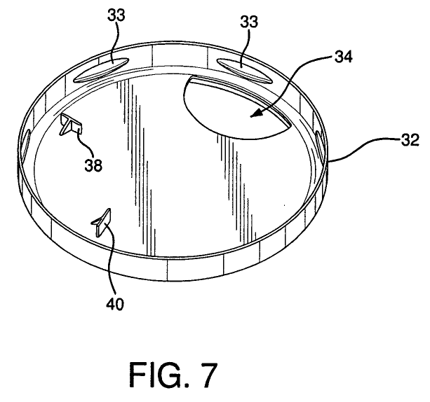

The lid 32 is structured to move between a closed position wherein the opening 34 is aligned with the top wall 36, a measured dispensing position wherein the opening 34 is aligned with the top opening 24 of the dispensing channel 18, and a pouring position wherein the opening 34 is in direct communication with the storage chamber 16. As shown in FIG. 6, the lid 32 is generally round and rotatably mounted on the side wall 12 of the container 11. As illustrated in FIG. 7, the bottom surface of the lid 32 includes a plurality of projections 33 that are structured to engage under a rim 35 disposed at the top of the side wall 12 (FIG. 4), thereby securing the lid 32 to the container 11.

Means is defined on the bottom surface of the lid 32 to form a rotational stop. The stop 38 is formed so that it abuts the channel wall 20 when the lid 32 is rotated toward the closed position. The stop 38 resists further rotational movement of the lid 32 substantially beyond the closed position and fixes the position of the lid 32. Likewise, stop 40 is formed to abut the top wall 36, when the lid 32 is rotated to the pouring position. In this position, the opening 34 in the lid 32 is aligned with the chamber 16. The stop 40 fixes the position of the lid 32 and resists rotational movement beyond the continuous pouring position. In addition to the above, or as an alternative, the fixing means may comprise a detent defined on either the lid 32 or the side wall 12 which mates with a projection defined on the other of the side wall 12 and lid 32 to provide resistance to movement of the lid 32 out of the closed position, the measuring position or the pouring position.

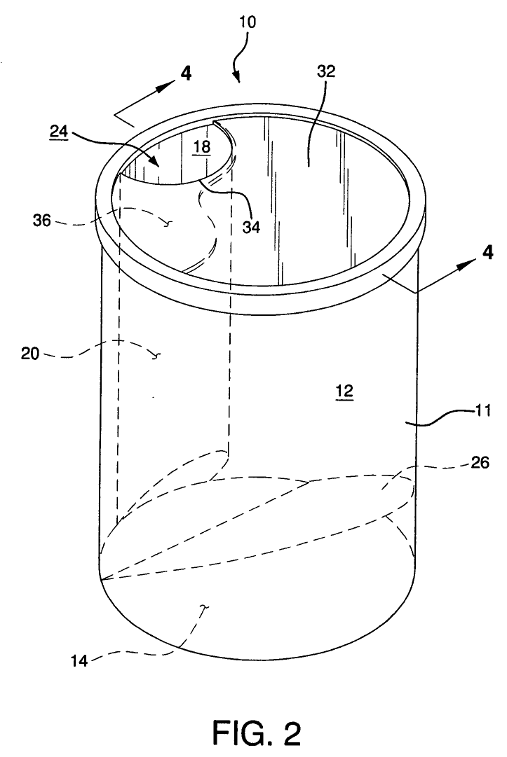

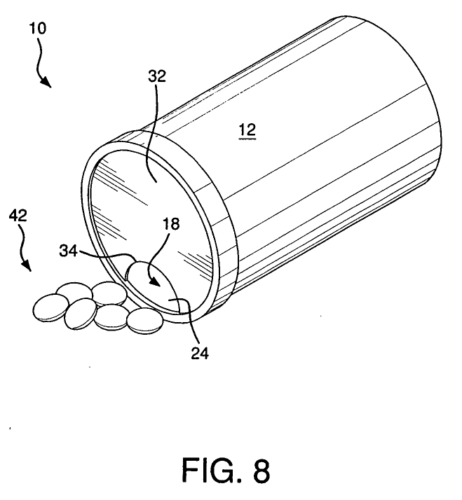

In use, the storage chamber 16 is filled with material. In the example shown in FIGS. 4, 8 and 9, the material to be dispensed is candy 42 in pellet form. When the dispenser 10 is in the upright position of FIGS. 1-4, the material 42 will flow down the ramp 26 into the bottom opening 22 of the dispensing channel 18 until a sufficient quantity of material 42 fills the dispensing channel 18. The lid 32 will typically be kept in the closed position of FIG. 1, wherein the opening 34 is aligned with the top wall 36. It should be understood, however, other positions are possible. A user wishing to dispense a measured quantity of the material 42 moves the lid 32 from its closed position (FIG. 1) to its measured dispensing position (FIGS. 2 and 8), wherein the lid opening 34 is aligned with the top opening 24 of the dispensing channel 18. Tilting the dispenser 10 (FIG. 8) will then cause the material 42 that has accumulated within the bottom opening 22 of the dispensing channel 18 (see FIG. 4) to move through top opening 24 and lid opening 34.

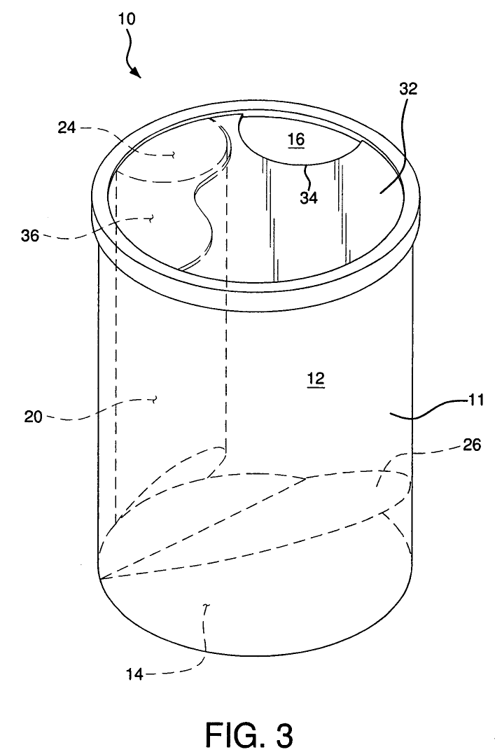

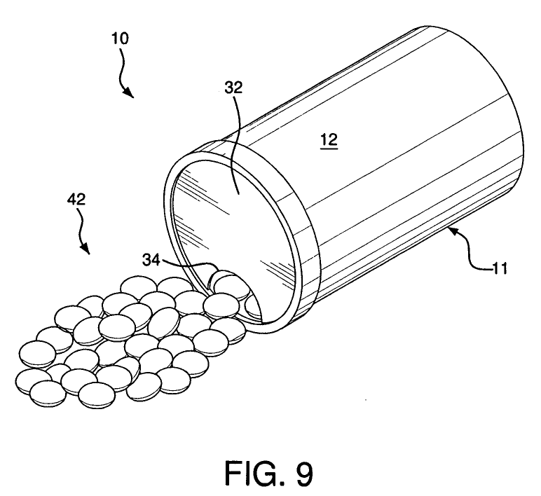

A user wishing to pour a non-measured quantity of material 42 will move the lid 32 to the pouring position of FIGS. 3 and 9. Tilting the dispenser 10 to the position of FIG. 9 will cause material 42 to flow out of the storage chamber 16 and through the lid opening 34 for as long as the dispenser 10 is tilted.

The present invention provides a dispenser for granular or pellet material that permits either dispensing a measured quantity of material or, alternatively, a pouring position.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A dispenser comprising:
a storage chamber defined by a bottom and at least one side wall, the dispenser further defining a top rim;
a dispensing channel position adjacent the storage chamber, the dispensing channel defining a bottom opening in communication with the bottom of the storage chamber and a top opening;
a top wall disposed adjacent the top opening of the dispensing channel;
a lid secured to the top of the dispenser, the lid defining an opening therein, the lid being structured to move between a first position wherein the lid opening is closed by the top wall, a second position wherein the lid opening is substantially aligned with the dispensing channel, and a third position wherein the lid opening is in direct communication with the storage chamber.

2. The dispenser according to claim 1, wherein the storage chamber bottom includes a ramp structured to direct material within the storage chamber towards the bottom opening of the dispensing channel.

3. The dispenser according to claim 1, wherein the lid is rotatably secured to the side wall of the storage chamber.

4. The dispenser according to claim 1, wherein the dispensing channel and the bottom opening of the dispensing channel are dimensioned and configured to dispense a substantially fixed quantity of material.

5. The dispenser according to claim 1, further comprising means for fixing the lid in the first position.

6. The dispenser according to claim 5, wherein the fixing means comprises at least one projection defined on the lid that engages the dispensing channel.

7. The dispenser of claim 5, further comprising a second means for fixing the position of the lid, the second fixing means fixing the lid in the third position.

8. The dispenser of claim 7, wherein the second fixing means comprises a second projection defined on the lid that engages the top wall when the lid is rotated to the third position.

9. The dispenser of claim 1, wherein the dispensing channel is formed by a channel wall which is attached to the side wall of the storage chamber and defined a channel there between.

10. The dispenser of claim 2, wherein the top wall is integrally formed with the channel wall.
